(19) United States
(12) Patent Application Publication
(10) Pub. No.: US 2007/0065584 A1
(43) Pub. Date: Mar. 22, 2007

(54) Spray-on paint protection film and method of applying same

(76) Inventors: John F. Ryan, Missoula, MT (US); Eric Rosenthal, Long Beach, NY (US); Richard P. Granito, Georgetown, FL (US)

Correspondence Address: ANTOINETTE M. TEASE, P. O. BOX 51016, BILLINGS, MT, 59105, US

(21) Appl. No.: 10/595,539

(22) PCT Filed: Oct. 25, 2004
(86) PCT No.: PCT/US04/35090

§ 371 Date: Oct. 16, 2006

Related U.S. Application Data
(60) Provisional application No. 60/517,186, filed on Nov. 3, 2003.

(51) Int. Cl. B05D 1/32; B05D 3/02; B05D 1/02; C08F 20/00

(52) U.S. Cl. 427/282; 427/421.1; 427/384; 525/440

(57) ABSTRACT

A method of protecting the paint on a vehicle from being chipped, scratched or corroded, comprising the steps of: (a) masking off those parts of the vehicle that are not to be coated; (b) spraying the remaining parts of the vehicle with a clear, protective coating to a thickness of four to fourteen mils or to a thickness that is three to five times the thickness of an OEM clear coat; (c) allowing the vehicle to air dry or force curing the vehicle with heat lamps; and (d) unmasking the vehicle. A spray-on protection film comprising a mixture of polyester resins and a high solids aliphatic polyisocyanate resin hardener, wherein the film is sprayed onto all or part of a vehicle to a thickness of four to fourteen mils or to a thickness that is three to five times the thickness of an OEM clear coat.

### CROSS-REFERENCE TO RELATED APPLICATION

This application claims priority back to U.S. Provisional Application No. 60/517,186, filed on Nov. 3, 2003.

### BACKGROUND OF THE INVENTION

1. Field of the Invention

The present invention relates to a spray-on product for the protection of paint on vehicles. The product is applied after the OEM finish that is applied at the factory and will reduce and prevent damage caused by stone chipping, scratches, bugs and weathering more effectively than the OEM finish. It is also easier to apply and more cost-effective than current after-market paint protection technologies.

2. Description of the Related Art

Factory coatings on automotive vehicles are prone to chipping, scratching and peeling. The deterioration of the outside coating of the vehicle not only has an aesthetic impact that lessens the value of the vehicle, but it can also lead to rusting and corrosion of the vehicle body. Although the phenomenon of chipping and scratching of painted vehicles occurs everywhere, the problem is particularly egregious in those areas of the world where gravels mixed with rock salt are laid on roads to prevent them from freezing. In that situation, particles of rock salt often collide with the coated surfaces of the vehicle body, causing localized chipping and peeling. The typical OEM coatings are not sufficient to withstand this kind of abuse.

New vehicles are delivered from the manufacturer painted with a system that will usually consist of an electrodeposition primer followed by a primer surfacer, a colored basecoat and a final clear coat. The final clear coat is a spray-applied film that has been baked on to a DFT of approximately 2.5 mils. During the life of a new car or truck, the vehicle experiences the normal array of dings, dents, scratches and chips in the paint finish. The baked-on OEM clear coat is designed to withstand a substantial number of chips and scratches, but as all new vehicle owners will confirm, it is inevitable that a vehicle will ultimately experience a large stone chip that has ruined the paint or a deep chip or scratch that has removed the paint right down to the primer or even down to the steel itself. A new vehicle generally maintains a significant percentage of its resale value through the end of the third year. The cleaner and more chip-free a vehicle's paint finish is at the end of the third year, the greater its resale value will be.

The current after-market solution for the problem of vehicle chipping is a product manufactured by 3M. The product is a paint protection film that is applied after the vehicle leaves the factory, and it is touted by 3M as a “yellowing-resistant” urethane film that protects against stone chips, bug damage, abrasion and weathering. The film is sold in rolls of varying widths, it needs to be maintained at a particular relative humidity, and it has to be used within one year of purchase. The product is applied in a sheet form cut from rolls of the adhesive-backed, pressure-sensitive material. According to 3M's own web site, application of the film to the entire vehicle would be difficult and expensive, and the product is intended to be applied only to the most vulnerable areas of the vehicle. A product similar to the 3M film described above is disclosed in U.S. Pat. No. 5,731,089 (Kuniklyo et al., 1998).

There are two other products on the market that are very similar to the film manufactured by 3M. The first is an adhesive film made by Venture Tape Corporation. This product is called VENTURE SHIELD, and it is applied in the same manner as the 3M product. It is marketed for the protection of “high incidence” areas such as the nose, wheel wells and bumpers. It has the same limitations in terms of storage, use and application, as the 3M film product. The second product is a protective film called “StoneShield” that is marketed by Avery Dennison. According to Avery Dennison's literature, the product “is typically applied along the front edge of a vehicle's hood, its bumpers and rocker panels, as well as around key locks and door handles, and anywhere else needing protection from stone chips, abrasion, and minor impacts that mar a vehicle's finish.” The film is eight mils thick, and Avery Dennison subjects the film to a proprietary heat treating process which they claim improves the film's gloss level. It is applied in the same manner as the 3M and Venture Tape films.

Unlike the 3M, Venture Tape and Avery Dennison products, the present invention is a spray-applied product, not a dry film application. The goal of the present invention is to achieve the same level of protection as these dry films in a spray-on application. There are numerous patents directed toward paint, primer and clear coat compositions for the automotive industry, but none that discloses a clear, rubberized after-market refinish product that is sprayed onto the vehicle, as in the present invention. The present invention is superior in appearance to these dry films because it is clearer and smoother due to the lack of an adhesive layer.

Examples of patents or patent applications dealing with coatings for painted surfaces (and for automotive vehicles in particular) are: U.S. Publication No. 2003/0170397 (Campbell et al.); U.S. Publication No. 2003/0170395 (Highcock et al.); U.S. Publication No. 2003/0045653 (Flosbach et al.); U.S. Publication No. 2003/0034719 (Sapper); U.S. Publication No. 2002/0197411 (Colyer et al.), U.S. Publication No. 2002/0086115 (Lamers et al.); U.S. Publication No. 2002/0015795 (Toui et al.); U.S. Pat. No. 6,623,795 (Yamada et al., 2003); U.S. Pat. No. 6,545,117 (Moos et al.,

2003); U.S. Pat. No. 6,620,511 (Wigger et al., 2003); U.S. Pat. No. 6,592,944 (Uhlianuk et al., 2003); U.S. Pat. No. 6,544,593 (Nagata et al., 2003); U.S. Pat. No. 6,432,484 (Corcoran et al., 2002); U.S. Pat. No. 6,319,557 (Ikushima et al., 2001); U.S. Pat. No. 6,309,707 (Mayer et al., 2001); U.S. Pat. No. 6,099,912 (Borgholte et al., 2000); U.S. Pat. No. 5,907,024 (Ohrbom et al.); U.S. Pat. No. 5,853,809 (Campbell et al., 1998); U.S. Pat. No. 5,759,631 (Rink et al., 1998); U.S. Pat. No. 5,064,688 (Trifon, 1991); U.S. Pat. No. 4,971,837 (Martz et al., 1990); and U.S. Pat. No. 4,533,703 (Kordomenos et al., 1985).

U.S. Pat. No. 5,380,565 (Gross et al., 1995) involves a water-dilutable spray coating with carboxyl polyol-derived polyester and epoxy resin. It is distinguishable from the present invention because the present invention is not water-dilutable. U.S. Pat. No. 4,268,547 (Backhouse, 1981) describes an improvement for spray-applied coatings for automobiles. The improvement involves the use of polymer microparticles that are stably dispersed in a resin solution. These microparticles are not at issue in the present invention.

U.S. Pat. No. 6,569,938 (Puett, 2003) is directed to a protective coating for painted surfaces. The patent claims a method of protecting an automobile surface from foreign elements or objects, comprising the steps of: (i) providing a quantity of flowable protective composition comprising an anionic polymer dispersed in a solvent; and (ii) applying the composition to the surface and allowing it to dry to form a coating with a hardness of at least 70 on the ASTM D2240-97 durometer A scale. The protective coating can be removed with high pressure water or by applying a remover solution and then rinsing the surface or wiping it clean. The patent states that the coating can be used over windows to protect them while the area around them is being painted (presumably the coating would be removed after the painting is completed). This patent is distinguishable from the present invention because the present invention does not involve an anionic polymer and cannot be removed once it is applied.

U.S. Publication No. 2003/0163910 (Tojo et al.) relates to a method of spraying a strippable liquid paint on the surface of a large-sized product finished with a sprayed coating, such as an automobile, to form a protective film. It is distinguishable from the present invention because the present invention is not a strippable paint but a permanent, after-market clear coat that is applied over the OEM finish. U.S. Publication No. 2003/0040567 (Hille) is also distinguishable from the present invention because it discloses a water-dilutable stone impact protection paint that is designed to assume the function of the conventional primer surfacer and/or the function of the conventional base coat layer and is not intended to function as a clear coat.

There are also several patents that address spraying systems for coating compositions. Examples include U.S. Pat. No. 6,601,733 (Schnacky et al., 2003); U.S. Pat. No. 6,409,098 (Lewis et al., 2002); and U.S. Pat. No. 6,383,572 (De Graaf et al., 2002). The present invention can be used with any conventional or HVLP spray system, including, but not limited to, gravity feed, suction or siphon feed, suction or siphon feed with pressure assist, pressure feed from a cup or tank/pot, and plural component spray systems.

It is an object of the present invention to provide a clear spray designed to reduce stone chipping, scratches, bug damage, abrasion and weathering on automotive vehicle surfaces. It is a further object of the present invention to provide superior results and ease of application as compared to existing OEM and after-market clear coats or protective films.

### BRIEF SUMMARY OF THE INVENTION

The present invention covers a method of protecting the paint on a vehicle from being chipped, scratched or corroded, comprising the steps of: (a) masking off those parts of the vehicle that are not to be coated; (b) spraying the remaining parts of the vehicle with a clear, protective coating to a thickness of four to fourteen mils or to a thickness that is three to five times the thickness of an OEM or auto body shop repair clear coat; (c) allowing the vehicle to air dry or force curing the vehicle with heat lamps; and (d) unmasking the vehicle. The present invention further specifies that the protective coating is a clear, rubberized coating and that the coating comprises two components, the first comprising polyester resins, and the second comprising a high solids aliphatic polyisocyanate resin hardener. The two components are mixed in a four-to-one ratio, and the protective coating is applied within three hours after the first and second components are mixed together. The protective coating of the present invention is sprayed over a vehicle's OEM finish using any conventional spray system.

The present invention also covers a spray-on protection film comprising a mixture of polyester resins and a high solids aliphatic polyisocyanate resin hardener, wherein the film is sprayed onto all or part of a vehicle to a thickness of four to fourteen mils or to a thickness that is three to five times the thickness of an OEM or auto body shop repair clear coat. The present invention further specifies that the film comprises two components that are mixed together in a four-to-one ratio before the product is applied to the vehicle. The first component comprises polyester resins, and the second component comprises a high solids aliphatic polyisocyanate resin hardener.

### BRIEF DESCRIPTION OF THE DRAWINGS

FIG. 1 is an illustration of one embodiment of those areas of an automobile that can be covered with the spray-on film of the present invention.

FIG. 2 is an illustration of one embodiment of those areas of a truck that can be covered with the spray-on film of the present invention in a preferred embodiment.

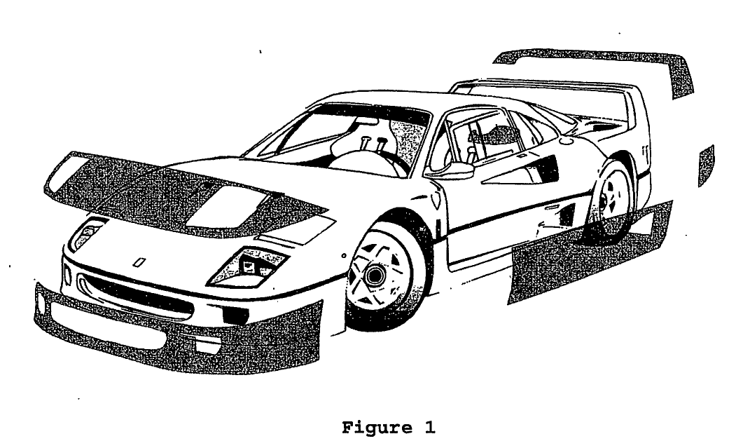

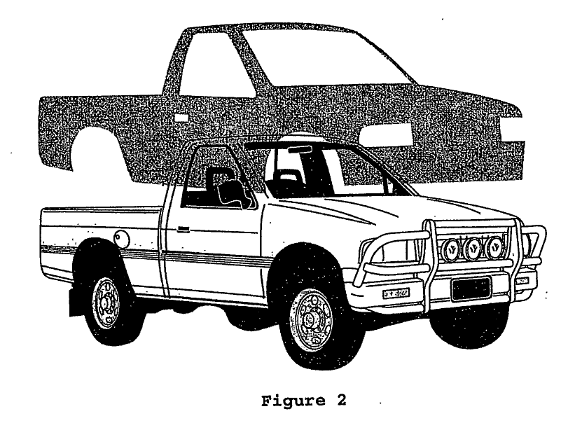

Application of the spray-on film of the present invention is not limited to the areas shown in FIGS. 1 and 2.

### DETAILED DESCRIPTION OF THE INVENTION

The present invention is a clear, after-market paint protection coating formulated for high build application in a controlled shop environment. When sprayed and cured over an existing OEM base coat and clear finish, the highly flexible and impenetrable properties of the present invention will reduce and prevent damage caused by stone chipping, scratches, bugs and weathering. The four- to fourteen-mil application of the chip prevention coating of the present invention is invisible to the eye but is so significantly thicker and more resilient than an OEM or auto body repair clear coat that even large stones that typically shatter an OEM finish and leave a chip or crater down to bare primer, or even the metal, cause no damage to a vehicle's paint. The present invention is designed for cars, trucks, motor homes, over-the-road trucks, motorcycles or any other painted surface that needs to be protected from the elements and damage that normally occur during the course of daily driving. Areas not to be covered are masked off prior to application. After spray application of the coating, the vehicle is allowed to air dry or is force cured with heat lamps, and then it is unmasked and returned to the customer.

The protective film of the present invention consists of two components, the first being a combination of polyester resins in a solvent, and the second being a high solids aliphatic polyisocyanate resin hardener in a solvent. These two components are mixed in a 4 to 1 ratio, and the mixed product must be applied within three hours of mixing. The chip prevention coating of the present invention is optically clear and is applied to a DFT of three to five times that of an OEM or auto body shop repair clear coat. If a traditional clear coat were applied to the same DFT, it would become brittle and crack like a piece of fiberglass when hit with a large stone or other hard object. Formulated from a highly flexible combination of polyester resins and catalyzed with a high solids aliphatic polyisocyanate resin, the coating of the present invention will not yellow over time, and the addition of a highly advanced ultraviolet protection package helps the coating maintain its gloss and distinctness of image (DOI) so that it cannot be distinguished from the rest of a vehicle's OEM clear appearance. Like a traditional clear coat, the coating of the present invention is completely resistant to gasoline and any chemicals with which an automotive finish normally comes into contact.

The chip prevention coating of the present invention is more elastic than the traditional factory-applied or after-market body repair coatings. It has an unusual feel to its surface in that it is soft but not sticky, yet hard and extremely resilient and scratch-proof. It has a rubber buoyancy that causes stones and other debris to bounce off the coating. It has a tremendous film thickness and resiliency that is not found in any other product on the market. This unique combination of properties gives the coating an unusual ability to ward off chips and scratches far more effectively than traditional OEM and auto body repair shop clear coats. As far as the inventors of the present invention are aware, there are no other similar products on the market that can be sprayed onto all or part of a vehicle.

The spray-on film of the present invention can literally be applied to any or all parts of a vehicle. FIG. 1 is an illustration of one embodiment of those areas of an automobile that can be covered with the spray-on film of the present invention. FIG. 2 is an illustration of one embodiment of those areas of a truck that can be covered with the spray-on film of the present invention. The shaded panels indicate where the film would be applied. Application of the spray-on film of the present invention is not limited to the areas shown in FIGS. 1 and 2.

Gravelometer tests have been conducted on metal panels that were coated first with primer, second with paint, and third with the spray-on paint protection film of the present invention. The gravelometer is designed for testing automotive materials and coatings for resistance to chipping by gravel impact. The gravelometer test complies with SAE, ASTM, VDA, GM, Ford, Chrysler, Mazda, JIS, Nissan, VW and Toyota test specifications. In a gravelometer test conducted in July of 2004 under the SAE J400 test method, a pint of gravel was shot at the panels at 70 psi at a 90-degree orientation. In this particular test, the panels had been preconditioned to a temperature of −30° C. The test results showed only minimal damage to the topcoat and no penetration to the painted substrate, thus confirming the efficacy of the present invention.

Although a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

### Definitions

The term “aliphatic” means of, relating to, or designating a group or organic chemical compounds in which the carbon atoms are linked in open chains.

The term “DFT” means dry film thickness.

The term “HVLP” means high-volume, low-pressure.

The term “mil” means a unit of length equal to one thousandth (10⁻³) of an inch (0.0254 millimeter), used, for example, to specify the diameter of wire or the thickness of materials sold in sheets.

The term “OEM” means original equipment manufacturer.

The term “rubberized” means having an elasticity greater than traditional factory-applied or after-market body repair coatings.

We claim:

1. A method of protecting the paint on a vehicle from being chipped, scratched or corroded, comprising the steps of:
(a) masking off those parts of the vehicle that are not to be coated;
(b) spraying the remaining parts of the vehicle with a clear, protective coating to a thickness of four to fourteen mils;
(c) allowing the vehicle to air dry; and
(d) unmasking the vehicle.

2. A method of protecting the paint on a vehicle from being chipped, scratched or corroded, comprising the steps of:
(a) masking off those parts of the vehicle that are not to be coated;
(b) spraying the remaining parts of the vehicle with a protective coating to a thickness of four to fourteen mils;
(c) force curing the vehicle with heat lamps; and
(d) unmasking the vehicle.

3. A method of protecting the paint on a vehicle from being chipped, scratched or corroded, comprising the steps of:
(a) masking off those parts of the vehicle that are not to be coated;
(b) spraying the remaining parts of the vehicle with a protective coating to a thickness that is three to five times the thickness of an OEM or auto body shop repair clear coat;
(c) allowing the vehicle to air dry; and
(d) unmasking the vehicle.

4. A method of protecting the paint on a vehicle from being chipped, scratched or corroded, comprising the steps of:
(a) masking off those parts of the vehicle that are not to be coated;
(b) spraying the remaining parts of the vehicle with a protective coating to a thickness that is three to five times the thickness of an OEM or auto body shop repair clear coat;
(c) force curing the vehicle with heat lamps; and
(d) unmasking the vehicle.

5. The method of claims 1, 2, 3 or 4, wherein the protective coating comprises a clear, rubberized coating.

6. The method of claim 5, wherein the protective coating comprises two components, the first component comprising polyester resins, and the second component comprising a high solids aliphatic polyisocyanate resin hardener.

7. The method of claim 6, further comprising mixing the first component and the second component in a four-to-one ratio before applying the protective coating to the vehicle.

8. The method of claim 7, wherein the protective coating is applied to the vehicle within three hours after the first and second components are mixed together.

9. The method of claims 1, 2, 3 or 4, wherein the coating is sprayed with a conventional spray system selected from the group consisting of gravity feed, suction or siphon feed, suction or siphon feed with pressure assist, pressure feed from a cup or tank/pot, and plural component spray systems.

10. The method of claims 1, 2, 3 or 4, wherein the protective coating is applied over the vehicle's OEM finish.

11. A spray-on protection film comprising a mixture of polyester resins and a high solids aliphatic polyisocyanate resin hardener, wherein the film is sprayed onto all or part of a vehicle to a thickness of four to fourteen mils.

12. A spray-on protection film comprising a mixture of polyester resins and a high solids aliphatic polyisocyanate resin hardener, wherein the film is sprayed onto all or part of a vehicle to a thickness that is three to five times the thickness of an OEM or auto body shop repair clear coat.

13. A spray-on protection film comprising a first and second component, wherein the first component comprises polyester resins and the second component comprises a high solids aliphatic polyisocyanate resin hardener, and wherein the first and second components are mixed in a four-to-one ratio and sprayed onto all or part of a vehicle to a thickness of four to fourteen mils.

14. A spray-on paint protection film comprising a first and second component, wherein the first component comprises polyester resins and the second component comprises a high solids aliphatic polyisocyanate resin hardener, and wherein the first and second components are mixed in a four-to-one ratio and sprayed onto all or part of a vehicle to a thickness that is three to five times the thickness of an OEM or auto body shop repair clear coat.
